(19) United States
(12) Patent Application Publication
(10) Pub. No.: US 2022/0253674 A1
(43) Pub. Date: Aug. 11, 2022

(54) SPIKING NEURAL NETWORK SYSTEM, LEARNING PROCESSING DEVICE, LEARNING METHOD, AND RECORDING MEDIUM

(71) Applicants: NEC CORPORATION, Tokyo (JP); THE UNIVERSITY OF TOKYO, Tokyo (JP)

(72) Inventors: Yusuke SAKEMI, Tokyo (JP); Kai MORINO, Tokyo (JP); Kazuyuki AIHARA, Tokyo (JP)

(73) Assignees: NEC CORPORATION, Tokyo (JP); THE UNIVERSITY OF TOKYO, Tokyo (JP)

(21) Appl. No.: 17/595,731

(22) PCT Filed: May 18, 2020
(86) PCT No.: PCT/JP2020/019652

§ 371 Date: Nov. 23, 2021

(30) Foreign Application Priority Data
May 30, 2019 (JP) 2019-101531

(51) Int. Cl. G06N 3/04; G06N 3/08

(52) U.S. Cl. CPC G06N 3/049; G06N 3/08

(57) ABSTRACT

A spiking neural network system includes: a time-based spiking neural network; and a learning processing unit that causes learning of the spiking neural network to be performed by supervised learning using a cost function, the cost function using a regularization term relating to a firing time of a neuron in the spiking neural network.

### TECHNICAL FIELD

The present invention relates to a spiking neural network system, a learning processing device, a learning method, and a recording medium.

### BACKGROUND ART

### (Spiking Neural Networks)

A spiking neural network (SNN) such as a feed-forward spiking neural network and a recurrent spiking neural network is a form of neural network. A spiking neural network is a network formed by connecting spiking neuron models (which are also called spiking neurons, or simply neurons).

### (Regarding Feed-Forward Spiking Neural Networks)

A feed-forward is a form of network in which the information transmission at the connections from layer to layer is in one direction. Each layer of a feed-forward spiking neural network is configured by one or more spiking neurons, and there are no connections between the spiking neurons in the same layer.

FIG. 11 is a diagram showing an example of a hierarchical structure of a feed-forward spiking neural network. FIG. 11 shows an example of a four-layer feed-forward spiking neural network. However, the number of layers in a feed-forward spiking neural network is not limited to four, and may be two or more.

As illustrated in FIG. 11, a feed-forward spiking neural network is configured in a hierarchical structure that receives a data input, and then outputs a computation result. The computation result output by a spiking neural network is also referred to as a predictive value or a prediction.

The first layer of a spiking neural network (layer 1011 in the example of FIG. 11) is referred to as the input layer. The last layer (fourth layer (layer 1014) in the example of FIG. 11) is referred to as the output layer. The layers between the input layer and the output layer (the second layer (layer 1012) and the third layer (layer 1013) in the example of FIG. 11) are referred to as hidden layers.

FIG. 12 is a diagram showing a configuration example of a feed-forward spiking neural network. FIG. 12 shows an example in which the four layers (layers 1011 to 1014) in FIG. 11 each have three spiking neurons (spiking neuron models) 1021. However, the number of spiking neurons included in a feed-forward spiking neural network is not limited to a specific number, and each layer may include one or more spiking neurons. Each layer may have the same number of spiking neurons, or different layers may have different numbers of spiking neurons.

The spiking neurons 1021 simulate the signal integration and spike generation (firing) that occurs in the cell body of a biological neuron cell.

The transmission pathways 1022 simulate the signal transmission that occurs in the axon and synapse of a biological neuron cell. The transmission pathways 1022 are arranged so as to connect two spiking neurons 1021 in adjacent layers, and transmit the spikes from a spiking neuron 1021 in the preceding layer to a spiking neuron 1021 in the subsequent layer.

Furthermore, the transmission pathways 1022 are not limited to connecting adjacent layers, and may be arranged so as to connect a spiking neuron 1021 in a certain layer with a spiking neuron 1021 in a layer reached by skipping an arbitrary number of layers ahead from the certain layer, such that spikes can be transmitted between these layers.

In the example of FIG. 12, the transmission pathways 1022 transmit the spikes from each of the spiking neurons 1021 in the layer 1011 to each of the spiking neurons 1021 in the layer 1012, from each of the spiking neurons 1021 in the layer 1012 to each of the spiking neurons 1021 in the layer 1013, and from each of the spiking neurons 1021 in the layer 1013 to each of the spiking neurons 1021 in the layer 1014.

### (Regrading Recurrent Spiking Neural Networks)

A recurrent is a form of network, and is a network having recursive connections. The configuration of a recurrent spiking neural network is a configuration which includes cases where the spikes generated in a certain spiking neuron are directly input back into itself, or cases where the spikes are input back into itself via another spiking neuron. Alternatively, a single recurrent spiking neural network may include cases where the spikes generated in a certain spiking neuron are directly input back into itself and cases where the spikes are input back into itself via another spiking neuron.

FIG. 13 is a diagram showing a configuration example of a recurrent spiking neural network. The recurrent spiking neural network illustrated in FIG. 13 includes four spiking neurons. However, the number of spiking neurons included in a recurrent spiking neural network is not limited to a specific number, and may include one or more spiking neurons.

The spiking neurons 10000 simulate the signal integration and spike generation (firing) that occurs in the cell body of a biological neuron cell.

The transmission pathways 10001 and the transmission pathways 10002 simulate the signal transmission that occurs in the axon and synapse of a biological neuron cell. The transmission pathways 10001 are arranged so as to connect two spiking neurons 10000, and transmit the spikes from a certain spiking neuron 10000 to another spiking neuron 10000. The transmission pathways 10002 are connections that return back to itself, and transmit the spikes from a certain spiking neuron 10000 back to itself

### (Description of Spiking Neuron Model)

A spiking neuron model has a membrane potential as an internal state, and is a model in which the membrane potential evolves over time according to a differential equation. A leaky integrate-and-fire neural network is known as a general spiking neuron model in which the membrane potential evolves over time according to a differential equation such as equation (1).

$$\begin{matrix}[ Equation 1 ] & \\ \frac{d}{dt} {v}_{i}^{( n )} ( t ) = - {α}_{leak} {v}_{i}^{( n )} ( t ) + {I}_{i}^{( n )} ( t ) , \\ {I}_{i}^{( n )} ( t ) = {\sum }_{j} {w}_{ij}^{( n )} r ( t - {t}_{j}^{( n - 1 )} ) & ( 1 )\end{matrix}$$

Here, v⁽ⁿ⁾ᵢ represents the membrane potential of the ith spiking neuron model in the nth layer. αₗₑₐₖ is a constant coefficient representing the magnitude of the leak in the leaky integrate-and-fire model. I⁽ⁿ⁾ᵢ represents the postsynaptic current of the ith spiking neuron model in the nth layer. W⁽ⁿ⁾ᵢⱼ is a coefficient that represents the strength of the connection from the jth spiking neuron model of the (n−1)th layer to the ith spiking neuron model of the nth layer, and is referred to as a weight.

In addition, t represents time. t⁽ⁿ⁻¹⁾ⱼ represents the firing timing (time of firing) of the jth neuron in the (n−1)th layer. r(·) is a function representing the effect that spikes transmitted from a preceding layer have on the postsynaptic current.

When the membrane potential exceeds a threshold value Vₜₕ, the spiking neuron model produces a spike (fires), and then the membrane potential returns to a reset value Vᵣₑₛₑₜ. Furthermore, the generated spike is transmitted to the connected spiking neuron models in the subsequent layer.

FIG. 14 is a diagram showing an example of the time evolution of the membrane potential of a spiking neuron. The horizontal axis of the graph in FIG. 14 represents time, and the vertical axis represents the membrane potential. FIG. 14 shows an example of the time evolution of the membrane potential of the ith spiking neuron in the nth layer, and the membrane potential is represented by v⁽ⁿ⁾ᵢ.

As mentioned above, Vₜₕ indicates a threshold value of the membrane potential. Vᵣₑₛₑₜ represents the reset value of the membrane potential. t⁽ⁿ⁻¹⁾₁ represents the firing timing of the first neuron in the (n−1)th layer. t⁽ⁿ⁻¹⁾₂ represents the firing timing of the second neuron in the (n−1)th layer. t⁽ⁿ⁻¹⁾₃ represents the firing timing of the third neuron in the (n−1)th layer.

The membrane potential v⁽ⁿ⁾ᵢ does not reach the threshold value Vₜₕ at either the first firing at time t⁽ⁿ⁻¹⁾₁ or the third firing at time t⁽ⁿ⁻¹⁾₃. On the other hand, the membrane potential v⁽ⁿ⁾ᵢ reaches the threshold value Vₜₕ at the second firing at time t⁽ⁿ⁻¹⁾₂, and then immediately drops to the reset value Vᵣₑₛₑₜ.

Spiking neural networks are expected to consume less power than deep learning models when implemented by hardware such as a CMOS (Complementary MOS). One reason for this is that the human brain is a computing medium having a low power consumption equivalent to 30 watts (W), and spiking neural networks are capable of mimicking the activity of a brain having such a low power consumption.

In order to create hardware with a low power consumption equivalent to that of a brain, it is necessary to develop spiking neural network algorithms that follow the calculation principles of a brain. For example, it is known that image recognition can be performed using a spiking neural network, and several supervised learning algorithms and unsupervised learning algorithms have been previously developed.

### (Regarding Information Transmission Methods of Spiking Neural Networks)

In terms of the algorithms of spiking neural networks, there are several information transmission methods that use spikes. Specifically, the frequency method and the time method are used.

In the frequency method, information is transmitted based on how many times a specific neuron fires in a fixed time interval. On the other hand, in the time method, information is transmitted based on the timing of spikes.

FIG. 15 is a diagram showing an example of spikes in both the frequency method and the time method. In the example of FIG. 15, in the frequency method, the information of “1”, “3”, and “5” is represented by a number of spikes that corresponds to the information. On the other hand, in the time method, the number of spikes is one in each case for the information “1”, “3”, and “5”, and the information is represented by generating a spike at a timing that corresponds to the information. In the example of FIG. 15, the neuron generates a spike at a later timing as the number corresponding to the information increases.

As shown in FIG. 15, the time method is capable of representing information with a smaller number of spikes than the frequency method. In Non-Patent Document 1, it is reported that in tasks such as image recognition, the time method can be executed with fewer than one-tenth the number of spikes used by the frequency method.

The power consumption of hardware increases as the number of spikes increases. Therefore, the power consumption can be reduced by using a time-based algorithm.

### (Regarding Prediction by Spiking Neural Networks)

It has been reported that various problems can be solved by using a spiking neural network. For example, in the network configuration shown in FIG. 11, it is possible to input image data to the input layer such that the spiking neural network is capable of predicting a label of the image. In the case of the time method, the output method of the predictive value may, for example, represent the predictive value by a label that corresponds to the neuron that fires (generates a spike) earliest among the neurons in the output layer.

### (Regarding Learning by Spiking Neural Networks)

A learning process is required for a spiking neural network to make correct predictions. For example, a learning task that recognizes an image uses image data, and label data representing the answers.

### (Regarding Learning Parameters)

The learning referred to here is a process that changes some of the parameter values of the network. The parameters whose these values are changed are referred to as learning parameters. For example, the strength of the connections in the network and spike transmission delays are used as learning parameters. Hereunder, the learning parameters are expressed as weights. However, the following description is not limited to connection strengths and can be extended to general learning parameters.

During learning, the spiking neural network receives data inputs and outputs predictive values. Further, a learning mechanism for causing the spiking neural network to perform learning, calculates a prediction error defined by the difference between the predictive value output by the spiking neural network and the label data (correct answer) or the like. The learning mechanism causes the spiking neural network to perform learning by optimizing the network weights of the spiking neural network so as to minimize a cost function defined by the prediction error.

### (Regarding Minimization of Cost Function)

For example, the learning mechanism can minimize a cost function C by repeatedly updating the weights as in equation (2).

$$\begin{matrix}[ Equation 2 ] & \\ Δ {w}_{ij}^{( l )} = - η \frac{\partial C}{\partial {w}_{ij}^{( l )}} & ( 2 )\end{matrix}$$

Here, Δw^{(l)}ᵢⱼ represents an increase or decrease in the weight w^{(l)}ᵢⱼ. When the value of Δw^{(l)}ᵢⱼ is positive, the weight w^{(l)}ᵢⱼ is increased. When the value of Δw^{(l)}ᵢⱼ is negative, the weight w^{(l)}ᵢⱼ is decreased.

In addition, η is a constant referred to as a learning coefficient.

C is a cost function, and is usually constructed by using a loss function L and a regularization term R as in equation (3).

[Equation 3]

C=L+R (3)

Decreasing the value of the loss function L corresponds to reducing the error during training in the machine learning process. The regularization term R is added for reasons such as improving generalization performance.

In the following, the cost function is denoted in terms of a single piece of data to simplify the notation. However, in the actual learning, the cost function is defined by a sum over all of the training data.

### (Regarding Definition of Loss Function by Squared Error)

In a spiking neural network, a method of defining the loss function L by the difference between the spike generation time in the output layer and the generation time of a teacher spike as in equation (4) is known from Non-Patent Document 2 and the like.

$$\begin{matrix}[ Equation 4 ] & \\ L = \frac{1}{2} {\sum }_{i} {( {t}_{i}^{( M )} - {t}_{i}^{( T )} )}^{2} & ( 4 )\end{matrix}$$

Here, t^{(M)}ᵢ represents the spike generation time of the ith neuron in the output layer (Mth layer). t^{(T)}ᵢ represents the generation time of the teacher spike (the spike generation time provided as the correct answer) of the ith neuron in the output layer (Mth layer).

### (Definition of Log-Likelihood Loss Function of Softmax Function)

In an artificial neural network, in a classification task, a method of defining a loss function L as a sum of (negative) log-likelihoods of a Softmax function as shown in equation (5) is known.

$$\begin{matrix}[ Equation 5 ] & \\ L = - {\sum }_{m} {κ}_{m} ln ( {S}_{m} ) , {S}_{m} = \frac{exp ( - output [ m ] )}{{\sum }_{i} exp ( - output [ i ] )} & ( 5 )\end{matrix}$$

Here, κₘ represents teacher label data, in which 0 is output for the correct label, and 0 is output otherwise. In represents the natural logarithm. Sₘ represents a function referred to as a Softmax function. output[i] represents the output of the ith neuron in the output layer.

The loss function L in equation (5) is known to have the effect of accelerating learning in classification problems.

Moreover, in Non-Patent Document 3, an example is described in which the output of the output layer neurons is expressed as in equation (6) and the loss function L of a multi-layer spiking neural network is defined as in equation (5) above using equation (6).

[Equation 6]

output[i]=exp(tᵢ^{(M)})=zᵢ^{(M)} (6)

Here, t^{(M)}ᵢ represents the firing timing of the ith neuron in the Mth layer (output layer).

In equation (6), the time t^{(M)}ᵢ of the output spike is transformed by the exponential function exp. The Softmax function in this case (Sₘ in which equation (6) has been substituted into equation (5)) is referred to as the definition of the Softmax function in the z region.

### (Regarding Stochastic Gradient Descent Method)

In the stochastic gradient descent method, weights are updated once using a portion of the training data. That is to say, the training data is divided into N non-overlapping groups, a gradient is calculated for the data in each group, and the weights are sequentially updated. Furthermore, when the weights are sequentially updated N times in total using each of the N groups, the learning is said to have advanced by one epoch. In the stochastic gradient descent method, convergence of the learning generally occurs after executing tens to hundreds of epochs. Moreover, updating of the weights using only one piece of data (one piece of input data and one piece of label data) is referred to as online learning, and updating of the weights using two or more pieces of data is called mini-batch learning.

### (Regarding Learning Speed)

The stochastic gradient descent method requires the network weights to be updated repeatedly. It is preferable to make the cost function smaller, and in addition, it is desirable to be able to make the cost function smaller with fewer updates. At this time, fast learning refers to minimization of the cost function with a smaller number of updates. Conversely, slow learning refers to a larger number of updates being spent to minimize the cost function. Fast learning enables a learning result to converge quickly.

### (Regarding Output of Prediction Result)

As mentioned above, it has been reported that various problems can be solved by using a feed-forward spiking neural network. For example, as described above, it is possible to input image data to the input layer such that the network is capable of predicting a label of the image.

FIG. 16 is a diagram showing an example of an output representation of a prediction result of the spiking neural network. For example, as shown in FIG. 16, in a task that recognizes an image of the three numbers from 0 to 2, three neurons that each correspond to the numbers 0 to 2 configure the output layer. Further, the number represented by the neuron that fires earliest becomes the prediction of the network. The operation of the network is time-based because the information is coded according to the firing timings of the neurons.

### PRIOR ART DOCUMENTS

### Non-Patent Documents

[Non-Patent Document 1] T. Liu, and 5 others. “MT-spike: A multilayer time-based spiking neuromorphic architecture with temporal error backpropagation”, Proceedings of the 36th International Conference on Computer-Aided Design, IEEE Press, 2017, p. 450-457

[Non-Patent Document 2] S. M. Bohte, and 2 others. “Error-backpropagation in temporally encoded networks of spiking neurons”, Neurocomputing, vol. 48, 2002, p. 17-37

[Non-Patent Document 3] H. Mostafa, “Supervised Learning Based on Temporal Coding in Spiking Neural Networks”, IEEE Transactions on Neural Networks and Learning Systems, No. 29, 2018, p. 3227-3235

### SUMMARY OF THE INVENTION

### Problem to be Solved by the Invention

It is preferable for the learning of a time-based spiking neural network to be performed with greater stability.

The present invention has an object of providing a spiking neural network system, a learning processing device, a learning method, and a recording medium that are capable of solving the above problem.

### Means for Solving the Problem

According to a first example aspect of the present invention, a spiking neural network system includes: a time-based spiking neural network; and a learning processing means for causing learning of the spiking neural network to be performed by supervised learning using a cost function, the cost function using a regularization term relating to a firing time of a neuron in the spiking neural network.

According to a second example aspect of the present invention, a learning processing device includes: a learning processing means for causing learning of a time-based spiking neural network to be performed by supervised learning using a cost function, the cost function using a regularization term relating to a firing time of a neuron in the spiking neural network.

According to a third example aspect of the present invention, a learning method includes: a step of performing learning of a time-based spiking neural network by supervised learning using a cost function, the cost function using a regularization term relating to a firing time of a neuron in the spiking neural network.

According to a fourth example aspect of the present invention, a recording medium stores a program that causes a computer to execute: a step of performing learning of a time-based spiking neural network by supervised learning using a cost function, the cost function using a regularization term relating to a firing time of a neuron in the spiking neural network.

### Effect of the Invention

According to the present invention, the learning of a time-based spiking neural network can be performed with greater stability.

### BRIEF DESCRIPTION OF THE DRAWINGS

FIG. 1 is a diagram showing an example of a schematic configuration of a neural network system according to an example embodiment.

FIG. 2 is a diagram showing an example of a hierarchical structure when a neural network device according to the example embodiment is configured as a feed-forward neural network.

FIG. 3 is a diagram showing a configuration example when the neural network device according to the example embodiment is configured as a feed-forward neural network.

FIG. 4 is a diagram showing a configuration example when the neural network device according to the example embodiment is configured as a recurrent neural network.

FIG. 5 is a graph showing an example of the learning progress of a simulation according to the example embodiment.

FIG. 6 is a diagram showing a configuration example of the neural network system according to the example embodiment.

FIG. 7 is a diagram showing a learning processing device according to the example embodiment.

FIG. 8 is a diagram showing an example of the processing steps in a learning method according to the example embodiment.

FIG. 9 is a schematic block diagram showing a configuration example of dedicated hardware according to at least one example embodiment.

FIG. 10 is a schematic block diagram showing a configuration example of an ASIC according to at least one example embodiment.

FIG. 11 is a diagram showing an example of a hierarchical structure of a feed-forward spiking neural network.

FIG. 12 is a diagram showing a configuration example of the feed-forward spiking neural network.

FIG. 13 is a diagram showing a configuration example of a recurrent spiking neural network.

FIG. 14 is a diagram showing an example of time evolution in the membrane potential of a spiking neuron.

FIG. 15 is a diagram showing an example of spikes in each of a frequency method and a time method.

FIG. 16 is a diagram showing an example of an output representation of a prediction result of the spiking neural network.

### EXAMPLE EMBODIMENT

Hereunder, example embodiments of the present embodiment will be described. However, the following example embodiments do not limit the invention according to the claims. Furthermore, all combinations of features described in the example embodiments may not be essential to the solution means of the invention.

### (Regarding Configuration of Neural Network System According to Example Embodiment)

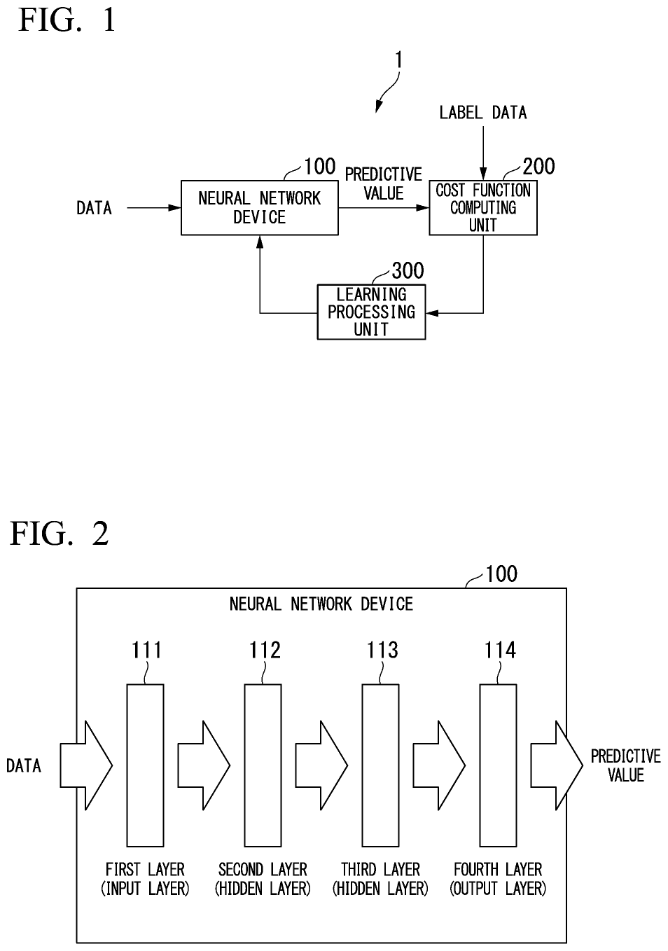

FIG. 1 is a diagram showing an example of a schematic configuration of a neural network system according to the example embodiment. In the configuration shown in FIG. 1, the neural network system 1 includes a neural network device 100, a cost function computing unit 200, and a learning processing unit 300.

In such a configuration, the neural network device 100 receives a data input and outputs a predictive value. As described above, the predictive value referred to here is a computation result output by the neural network.

The cost function computing unit 200 calculates a cost function value by inputting the predictive value output by the neural network device 100 and label data (correct answer), into a cost function that has been stored in advance. The cost function computing unit 200 outputs the calculated cost function value to the learning processing unit 300.

The learning processing unit 300 causes the neural network device 100 to perform learning using the cost function value calculated by the cost function computing unit 200. Specifically, the learning processing unit 300 updates the weights of the neural network of the neural network device 100 so as to minimize the cost function value.

The neural network device 100, the cost function computing unit 200, and the learning processing unit 300 may be configured as separate devices, or two or more of these devices may be configured as a single device. The learning processing unit 300 may be configured as a learning processing device.

### (Regarding Structure of Neural Network Device According to Example Embodiment)

FIG. 2 is a diagram showing an example of a hierarchical structure when the neural network device 100 is configured as a feed-forward neural network. In the example of FIG. 2, the neural network device 100 is configured as a four-layer feed-forward spiking neural network. However, the number of layers in the neural network device 100 is not limited to four as shown in FIG. 2, and may be two or more.

In the example of FIG. 2, the neural network device 100 functions as a feed-forward spiking neural network that receives a data input, and then outputs a predictive value.

Of the layers of the neural network device 100, the first layer (layer 111) corresponds to the input layer. The last layer (fourth layer, layer 114) corresponds to the output layer. The layers between the input layer and the output layer (the second layer (layer 112) and the third layer (layer 113)) correspond to the hidden layers.

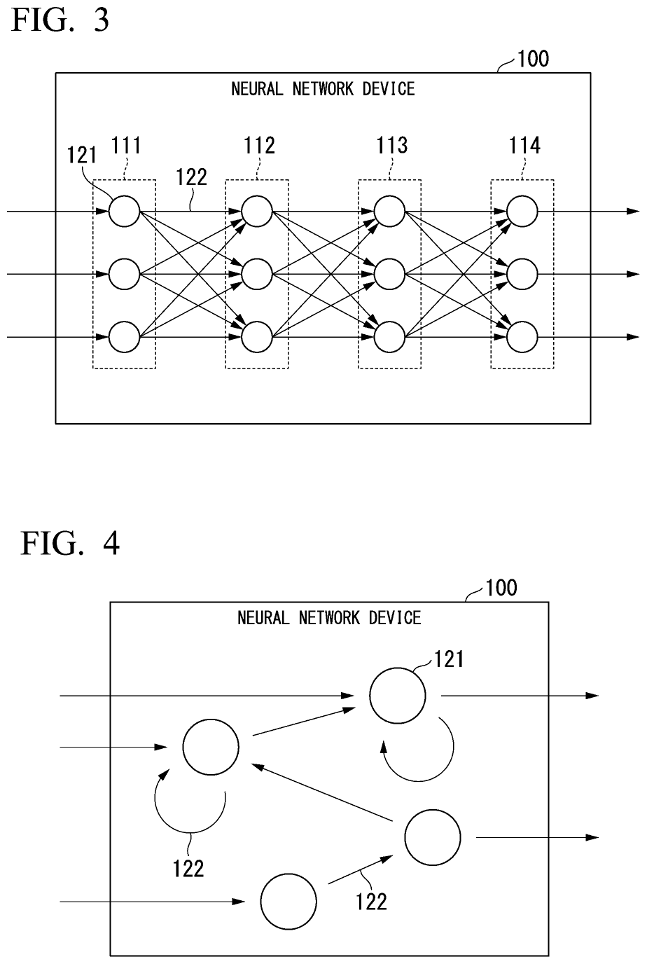

FIG. 3 is a diagram showing a configuration example when the neural network device 100 is configured as a feed-forward neural network. FIG. 3 shows an example in which the four layers (layers 111 to 114) in FIG. 2 each have three nodes (neuron model units 121). However, the number of neuron model units 121 included the neural network device 100 is not limited to a specific number. When the neural network device 100 is configured as a feed-forward neural network, each layer may include two or more neuron model units 121. Each layer may have the same number of neuron model units 121, or different layers may have different numbers of neuron model units 121. When the neural network device 100 is configured as a recurrent neural network, the number of neuron model units 121 included in the neural network device 100 is not limited to a specific number, and may include one or more neuron model units 121.

In the example of FIG. 3, the neuron model units 121 are configured as spiking neurons (spiking neuron models) and simulate the signal integration and spike generation (firing) that occurs in a cell body.

The transmission processing units 122 simulate the signal transmission by the axon and synapse. The transmission processing units 122 are arranged such that two neuron model units 121 are connected between arbitrary layers, and transmit spikes from the neuron model unit 121 on the preceding layer side to the neuron model unit 121 on the subsequent layer side.

In the example of FIG. 3, the transmission processing units 122 transmit spikes from each of the neuron model units 121 in the layer 111 to each of the neuron model units 121 in the layer 112, from each of the neuron model units 121 in the layer 112 to each of the neuron model units 121 in the layer 113, and from each of the neuron model units 121 in the layer 113 to each of the neuron model units 121 in the layer 114.

FIG. 4 is a diagram showing a configuration example when the neural network device 100 is configured as a recurrent neural network.

In the example of FIG. 4, like the case of FIG. 3, the neuron model units 121 are configured as spiking neurons and simulate the signal integration and spike generation that occurs in a cell body. Like the case of FIG. 3, the transmission processing units 122 simulate the signal transmission by the axon and synapse. The transmission processing units 122 are arranged such that two neuron model units 121 are connected, and transmit spikes from the neuron model unit 121 on the output side to the neuron model unit 121 on the input side.

The structure of the neural network device 100 in the example of FIG. 4 differs from the case of FIG. 3 in that the neuron model units 121 do not need to be arranged in a hierarchical structure. Furthermore, the structure of the neural network device 100 in the example of FIG. 4 differs from the case of FIG. 3 in that at least one of the signal transmission pathways formed by the transmission processing units 122 returns back to the neuron model unit 121 itself, which is the signal output source. The transmission pathway may directly return from the neuron model unit 121 serving as the signal output source back to the neuron model unit 121 itself, which is the signal output source. Alternatively, the transmission pathway may indirectly return from the neuron model unit 121 serving as the signal output source back to the neuron model unit 121 itself, which is the signal output source, via another neuron model unit 121. It is possible for both directly returning transmission pathways and indirectly returning transmission pathways to exist.

### (Regarding Loss Function of Neural Network Device According to Example Embodiment)

In the present example embodiment, in a classification problem, the loss function L computed by the cost function computing unit 200 during supervised learning of the multi-layer spiking neural network may be defined using the firing times (firing timings) t^{(M)}ᵢ of the output layer neurons, which is neuron model units 121, as in equation (7).

$$\begin{matrix}[ Equation 7 ] & \\ L = - {\sum }_{m} {κ}_{m} ln ( {S}_{m} ) , {S}_{m} = \frac{exp ( - a {t}_{m}^{( M )} )}{{\sum }_{i} exp ( - a {t}_{i}^{( M )} )} & ( 7 )\end{matrix}$$

As mentioned above, K. represents teacher label data, in which 1 is output for the correct label, and 0 is output otherwise. In represents the natural logarithm. S. represents a Softmax function.

a is a positive constant. t^{(M)}ᵢ represents the firing time of the ith neuron model unit 121 in the Mth layer (output layer). In a similar manner to i, m is used as an index to identify the neuron model units 121 (the m in each of “Σₘ” and “κₘ” in the equation on the left side, “Sₘ” in the equations on the left and right sides, and “t^{(M)}ₘ” in the equation on the right side).

In equation (7), the Softmax function is defined at the time of the output spike. Therefore, it is defined as a Softmax function in the t region (time region).

In comparison to a Softmax function in the z region (see equation (6)), a Softmax function in the t region (see equation (7)) requires a relatively simple calculation in that it is not necessary to apply an exponential function twice. In this respect, by using the log-likelihood of the Softmax function in the t region for the loss function, the calculation load is relatively light and further, the learning time is relatively short. Because the exponential function is applied to each output layer neuron, the effect of using the Softmax function in the t region is particularly large when the number of output layer neurons is large.

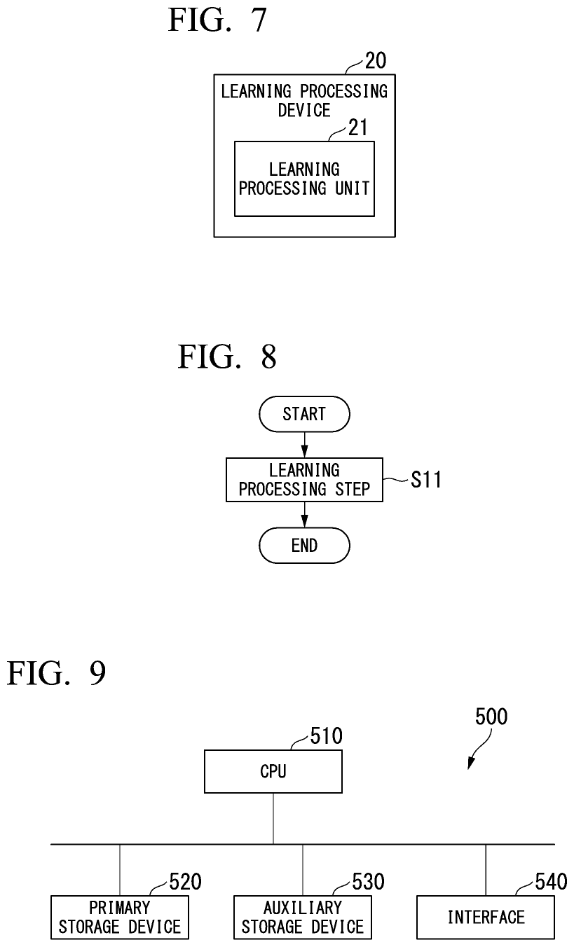

The loss function L in FIG. 7 is also applicable when the neural network device 100 is configured as a recurrent neural network. In this case, the neuron model units 121 that output signals to the outside of the neural network are treated as output layer neurons.

### (Effects of Learning According to Example Embodiment)

In a classification problem, the use of a loss function that uses the negative log-likelihood of the Softmax function causes the learning of the neural network system 1 to converge with a small number of epochs. Therefore, the learning becomes faster.

Furthermore, in the loss function computed by the cost function computing unit 200, the Softmax function is defined by natural exponential functions of the firing times as in equation (7) (that is to say, a Softmax function in the t region is used for the cost function). In this respect, the amount of calculation is smaller than when a Softmax function in the z region (see equation (6)) is used for the cost function.

### (Regarding Regularization Term of Cost Function of Neural Network Device According to Example Embodiment)

A Softmax function in the t region (see equation (7)) is invariant with respect to the transformation in equation (8).

[Equation 8]

tᵢ^{(M)}→tᵢ^{(M)}+c, for all i (8)

Furthermore, a Softmax function in the z region (see equation (6)) is invariant with respect to the transformation in equation (9).

[Equation 9]

zᵢ^{(M)}→zᵢ^{(M)}+c, for all i (9)

Here, c is an arbitrary real number. In equations (8) and (9), the arrow symbol represents the operation of replacing the value on the left side with the value on the right side.

Specifically, the value of the Softmax function does not change when an identical value c is uniformly added to “t^{(M)}ᵢ” in equation (8) to obtain “t^{(M)}ᵢ+c” for all spiking neuron models (neuron model units 121) in the Mth layer (output layer) (that is to say, for all i). Similarly, the value of the Softmax function does not change when an identical value c is added to “z^{(M)}ᵢ” to obtain “z^{(M)}ᵢ+c”.

As a result of this invariance, the position of the final layer spike (firing timing) is unable to be determined as a single point. Consequently, the learning can become unstable and fail relatively frequently. A failure occurring in the learning means that the cost function stops decreasing or starts to increase due to spikes no longer being generated during the learning and the like.

Therefore, in order to resolve the instability of the learning, the regularization term calculated by the cost function computing unit 200 is defined as a regularization term relating to the firing times of the neuron model units 121 in the neural network, and takes the form “αP(t^{(M)}₁, t^{(M)}₂, . . . , t^{(M)}_{N(M)}, t^{(M-1)}₁, t^{(M-1)}₂, . . . , t^{(M-1)}_{N(M-1)}, . . . )” as in equation (10).

[Equation 10]

R=αP(t₁^{(M)}, t₂^{(M)}, . . . , t_{N}_{^{(M)}}^{(M)}, t₁^{(M-1)}, . . . ,t_{N}_{⁽¹⁾}⁽¹⁾) (10)

Here, α is a coefficient for adjusting the degree of influence of the regularization term (specifically, for obtaining the weighted sum of the loss function and the regularization term), and can be a positive real constant. As described above, t^{(M)}i represents the firing time of the ith neuron in the Mth layer (output layer). N^{(l)} represents the number of neurons constituting the lth layer. P is a function of the firing times of the neurons.

The regularization term “αP(t^{(M)}₁, t^{(M)}₂, . . . , t^{(M)}_{N(M)}, t^{(M-1)}₁, t^{(M-1)}₂, . . . , t^{(M-1)}_{N(M-1)}, . . . )” is also referred to as the regularization term P. The regularization term P has the feature that it does not directly depend on the teacher data.

As shown in equation (10), the neuron model units 121 in which the regularization term P refers to firing times are not limited to being the neuron model units 121 in the output layer, and may be any of the neuron model units 121.

### (Effects of Learning According to Example Embodiment)

As mentioned above, in a classification problem, the learning of the neural network system 1 becomes faster due to the use of a loss function using a Softmax function. In addition, by adding a regularization term P relating to the firing times of the neuron model units 121 in the neural network to the cost function, the learning becomes more stable.

### (Regarding Specific Example of Penalty Term of Cost Function of Neural Network Device According to Example Embodiment)

As an example of the function P used for the regularization term P, it is possible to define the function as in equation (11) using the firing times of the output layer neurons.

$$\begin{matrix}[ Equation 11 ] & \\ P = \frac{1}{2} {\sum }_{i} {( {t}_{i}^{( M )} - {t}^{( ref )} )}^{2} & ( 11 )\end{matrix}$$

Here, t^{(ref)} is a constant which is referred to as the reference time.

### (Effects of Learning According to Example Embodiment)

As mentioned above, in a classification problem, the learning becomes faster due to the use of a loss function using a Softmax function. Furthermore, the learning becomes more stable as a result of imposing the regularization shown in equation (11) on the firing times of the output layer neurons.

### (Simulation Example)

A well-known benchmark task, MNIST, was used to simulate a classification task using a feed-forward spiking neural network. A similar classification task can be executed when the neural network device 100 is configured as a recurrent spiking neural network.

In the simulation, the neural network was configured by three layers (an input layer, a hidden layer, and an output layer). Furthermore, integrate-and-fire spiking neurons as shown in equation (12) were used as the neuron model units 121.

$$\begin{matrix}[ Equation 12 ] & \\ \frac{\partial }{\partial t} {v}_{i}^{( l )} ( t ) = {\sum }_{j} {w}_{i j}^{( l )} θ ( t - {t}_{j}^{( l - 1 )} ) & ( 12 )\end{matrix}$$

As mentioned above, t represents time. v^{(l)}ᵢ represents the membrane potential of the ith spiking neuron model in the lth layer. Here, the lth layer is not limited to being the output layer. Equation (12) applies to each spiking neuron model of the hidden layers and the output layer (second and subsequent layers). W^{(l)}ᵢⱼ is a coefficient that represents the weight of the connection from the jth spiking neuron model of the (l−1)th layer to the ith spiking neuron model of the lth layer.

θ is a step function and is expressed as in equation (13).

$$\begin{matrix}[ Equation 13 ] & \\ θ ( t ) = \{ \begin{matrix}0 & ( t < 0 ) \\ 1 & ( 0 \leq t )\end{matrix} & ( 13 )\end{matrix}$$

Furthermore, a cost function of the neural network using a loss function based on a square error function is defined as in equation (14).

$$\begin{matrix}[ Equation 14 ] & \\ {C}^{M S E} = \frac{1}{2} {\sum }_{i} {( {t}_{i}^{( M )} - {t}_{i}^{( T )} )}^{2} & ( 14 )\end{matrix}$$

As mentioned above, t^{(M)}ᵢ represents the spike generation time of the ith neuron in the output layer (Mth layer). t^{(T)}ᵢ represents the generation time of the teacher spike (the spike generation time provided as the correct answer) of the ith neuron in the output layer (Mth layer).

Moreover, the cost function based on the Softmax function is defined as in equation (15).

[Equation 15]

C^{SOFT}=L^{SOFT}+αP (15)

The term L^{SOFT} is expressed as in equation (16).

$$\begin{matrix}[ Equation 16 ] & \\ {L}^{SOFT} = - {\sum }_{i} {κ}_{i} ln ( {S}_{i} ) , {S}_{m} = \frac{exp ( - {t}_{m}^{( M )} )}{{\sum }_{i} exp ( - {t}_{i}^{( M )} )} & ( 16 )\end{matrix}$$

Here, “Sᵢ” in the equation on the left side is a Softmax function and is expressed as in the equation on the right side. The equation on the right side is written with “i” in the formula on the left side replaced with “m”, such as in “Sₘ”. This is to distinguish it from the “i” used in the denominator on the right side.

P in equation (15) is expressed as in equation (17).

$$\begin{matrix}[ Equation 17 ] & \\ P = \frac{1}{2} {\sum }_{i} {( {t}_{i}^{( M )} - {t}^{( ref )} )}^{2} & ( 17 )\end{matrix}$$

As described above, C^{MSE} (see equation (14)) is a loss function that uses square errors, and C^{SOFT} (see equation (15)) is a cost function that uses a weighted sum of the log-likelihood of the Softmax function and the regularization term P. A learning simulation was performed as described below for each of C^{MSE} and C^{SOFT} when those cost functions were used.

A differential in terms of the weights of the output layer can be calculated by the chain rule as shown in equation (18).

$$\begin{matrix}[ Equation 18 ] & \\ \frac{\partial C}{\partial {w}_{ij}^{( M )}} = \frac{\partial {t}_{i}^{( M )}}{\partial {w}_{ij}^{( M )}} \frac{\partial C}{\partial {t}_{i}^{( M )}} & ( 18 )\end{matrix}$$

Here, “∂C/∂t^{(M)}ᵢ” can be calculated as in equation (19) in the case of C^{MSE}, which uses a square error function.

$$\begin{matrix}[ Equation 19 ] & \\ \frac{\partial {C}^{M S E}}{\partial {t}_{i}^{( M )}} = ( {t}_{i}^{( M )} - {t}_{i}^{( T )} ) & ( 19 )\end{matrix}$$

Furthermore, C^{SOFT}, which uses a Softmax function, can be expanded as in equation (20).

$$\begin{matrix}[ Equation 20 ] & \\ \frac{\partial {C}^{SOFT}}{\partial {t}_{i}^{( M )}} = α \frac{\partial P}{\partial {t}_{i}^{( M )}} + {\sum }_{m} \frac{\partial {S}_{m}}{\partial {t}_{i}^{( M )}} \frac{\partial {L}^{SOFT}}{\partial {S}_{m}} , & ( 20 )\end{matrix}$$

The “∂P/∂t^{(M)}ᵢ” on the right side of equation (20) can be calculated as in equation (21).

$$\begin{matrix}[ Equation 21 ] & \\ \frac{\partial P}{\partial {t}_{i}^{( M )}} = ( {t}_{i}^{( M )} - {t}^{( ref )} ) & ( 21 )\end{matrix}$$

The “∂Sₘ/∂t^{(M)}ᵢ” on the right side of equation (20) can be calculated as in equation (22).

$$\begin{matrix}[ Equation 22 ] & \\ \frac{\partial {S}_{m}}{\partial {t}_{i}^{( M )}} = \{ \begin{matrix}{S}_{m} ( {S}_{m} - 1 ) , & for i = m \\ {S}_{m} {S}_{i} , & for i \neq m\end{matrix} & ( 22 )\end{matrix}$$

The “∂L^{SOFT}/∂Sₘ” on the right side of equation (20) is expressed as in equation (23).

$$\begin{matrix}[ Equation 23 ] & \\ \frac{\partial {L}^{S O F T}}{\partial {S}_{m}} = ( - \frac{{κ}_{m}}{{S}_{m}} ) & ( 23 )\end{matrix}$$

Furthermore, “∂t^{(M)}ᵢ/∂w^{(M)}ᵢⱼ” in equation (18) can be calculated as in equation (24).

$$\begin{matrix}[ Equation 24 ] & \\ \frac{\partial {t}_{i}^{( M )}}{\partial {w}_{i j}^{( M )}} = \frac{( t - {t}_{j}^{( M - 1 )} ) θ ( t - {t}_{j}^{( M - 1 )} )}{{\sum }_{j} {w}_{i j}^{( M )} θ ( t - {t}_{j}^{( M - 1 )} )} & ( 24 )\end{matrix}$$

From the above, it is possible to calculate the differential of the cost function by using the output layer. Similarly, it is possible to calculate the differential of the loss function by using the weights of the hidden layer. In the simulation, the learning was performed using the stochastic gradient descent method.

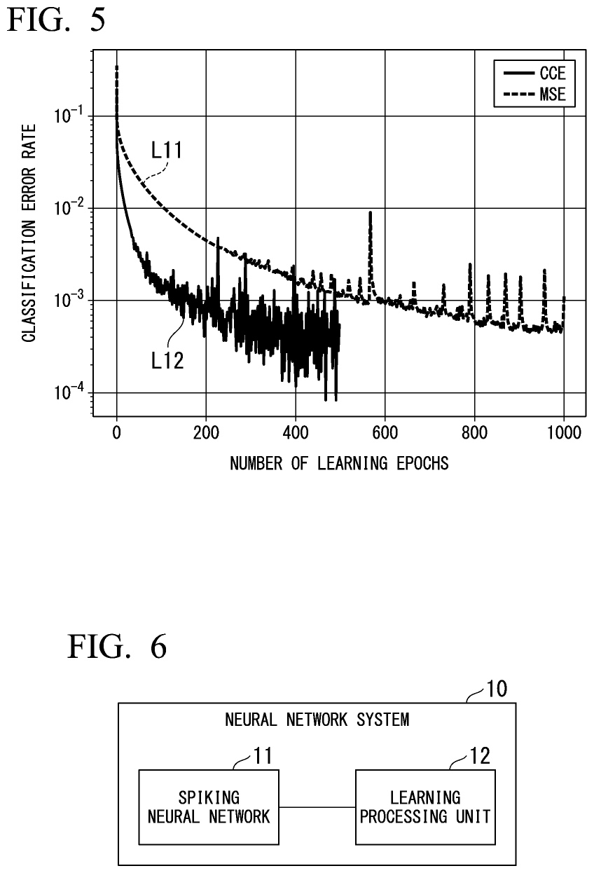

FIG. 5 is a graph showing an example of the learning progress of the simulations. The horizontal axis of the graph in FIG. 5 represents the number of learning epochs. The vertical axis represents the classification error rate. The line L11 shows the result when the cost function using a square error function (C^{MSE} from above) was used. The line L12 shows the result when the cost function using the sum of a loss function using a Softmax function and a regularization term P was used (C^{SOFT} from above).

When the cost function (C^{SOFT}) using the sum of a loss function using a Softmax function and a regularization term P was used, the classification error rate was reduced in a smaller number of learning epochs than when the cost function (C^{MSE}) using a loss function using a square error function was used. From this, it can be seen that the learning was faster when a cost function (C^{SOFT}) using the sum of a loss function using a Softmax function and a regularization term P was used.

As described above, the spiking neural network of the neural network device 100 is a time-based spiking neural network. The learning processing unit 300 causes learning of the spiking neural network to be performed by supervised learning using a cost function (see equation (10)) that includes a regularization term relating to the neuron firing times in the spiking neural network.

Specifically, the learning processing unit 300 updates the weights of the spiking neural network of the neural network device 100 based on the cost function value calculated by the cost function computing unit 200.

As a result, in the neural network system 1, it is possible to eliminate or reduce the learning instability caused by the invariance of the Softmax function in the t region with respect to the transformation of equation (8) above, and the learning instability caused by the invariance of the Softmax function in the z region with respect to the transformation of equation (9) above.

In this respect, according to the neural network system 1, the learning of the network (time-based spiking neural network) in the neural network device 100 can be performed with greater stability.

Furthermore, the learning processing unit 300 causes the neural network device 100 to perform the learning described above using a cost function that includes the regularization term mentioned above, and a loss function that uses a negative log-likelihood of a Softmax function, which is obtained by dividing a time index value obtained by inputting time information of an output spike that has been multiplied by a negative coefficient into an exponential function, by the sum of the time index values of all of the neurons in the output layer.

In the example of the equation (7), “t^{(M)}ₘ” corresponds to an example of time information of an output spike, and “−a” corresponds to an example of a negative coefficient. Furthermore, “exp(−at^{(M)}ₘ)” corresponds to an example of a time index value, and “Σᵢexp(−at^{(M)}ᵢ)” corresponds to an example of a sum of the time index values of all of the neurons in the output layer. Furthermore, the Softmax function Sₘ corresponds to an example of a probability distribution in that the sum of the values of the Softmax function Sₘ for all of the neuron model units 121 in the output layer is 1.

In this way, in the neural network system 1, the learning of the neural network of the neural network device 100 can be performed at higher speeds in the respect that a loss function using the negative log-likelihood of a Softmax function is used.

Further, in terms of the cost function, because a Softmax function in the t region is used, the amount of calculation is smaller than when a Softmax function in the z region is used. In this respect, the neural network system 1 is capable of increasing the speed of learning of the neural network of the neural network device 100.

When the processing of the learning processing unit 300 is executed by software, because the cost function is in the form of a relatively simple function, the processing load is relatively light, the processing time is relatively short, and the power consumption is relatively small. Furthermore, when the processing of the learning processing unit 300 is executed by hardware, because the cost function is in the form of a relatively simple function, the processing load is relatively light, the processing time is relatively short, and the power consumption is relatively small, and in addition, the hardware circuit area is relatively small.

In this way, in the neural network system 1, the learning of the neural network of the neural network device 100 can be performed at higher speeds, and the learning can be performed with greater stability.

Moreover, the learning processing unit 300 causes the learning to be performed using a regularization term based on the differences between the time information of the output spikes and a reference time that is a constant. Equations (11) and (17) above correspond to examples of the regularization term, which is based on the differences between the time information of the output spikes (firing times of the output layer neurons t^{(M)}ᵢ) and a reference time that is a constant (t^{(ref)}).

In the neural network device 100, the effect described above in which the learning can be performed with greater stability can be obtained by a relatively simple calculation such as the calculation of differences between time information. As described above, because the calculation is simple, the effect of being able to perform the learning at higher speeds can be ensured (that is to say, such an effect is not hindered).

Moreover, the learning processing unit 300 causes the learning to be performed using a regularization term based on square errors of the differences between the time information of the output spikes and a constant reference time. Equation (17) corresponds to an example of the regularization term based on square errors of the differences between the time information of the output spikes and a reference time that is a constant.

In the neural network device 100, the effect described above in which learning can be performed with greater stability can be obtained by a relatively simple calculation such as the calculation of square errors of the differences between time information. As described above, because the calculation is simple, the effect of being able to perform the learning at higher speeds can be ensured (that is to say, such an effect is not hindered).

Furthermore, in the neural network system 1, because the neuron model units 121 use the time method, less power is consumed than in the case of the frequency method.

Next, the configuration of the example embodiment of the present invention will be described with reference to FIG. 6 to FIG. 8.

FIG. 6 is a diagram showing a configuration example of a neural network system according to the example embodiment. The neural network system 10 shown in FIG. 6 includes a spiking neural network 11 and a learning processing unit 12.

In such a configuration, the spiking neural network 11 is a time-based spiking neural network. The learning processing unit 12 causes learning of the spiking neural network 11 to be performed by supervised learning using a cost function that includes a regularization term relating to the neuron firing times in the spiking neural network 11.

As a result, in the neural network system 10, it is possible to eliminate or reduce the learning instability caused by invariance of the Softmax function with respect to a transformation that adds a constant to the Softmax function.

In this respect, according to the neural network system 10, the learning of a time-based spiking neural network can be performed with greater stability.

FIG. 7 is a diagram showing a learning processing device according to the example embodiment.

The learning processing device 20 shown in FIG. 7 includes a learning processing unit 21.

In such a configuration, the learning processing unit 21 causes learning of the time-based spiking neural network to be performed by supervised learning using a cost function that includes a regularization term relating to the neuron firing times in the spiking neural network.

According to the learning processing device 20, it is possible to eliminate or reduce the learning instability caused by invariance of the Softmax function with respect to a transformation that uniformly adds an identical value to the firing times of all of the neurons in the output layer.

In this respect, according to the learning processing device 20, the learning of a time-based spiking neural network can be performed with greater stability.

FIG. 8 is a diagram showing an example of the processing steps in a learning method according to the example embodiment.

In the processing shown in FIG. 8, the learning method includes a learning processing step (step S11). In the learning processing step (step S11), learning of the time-based spiking neural network is performed by supervised learning using a cost function that includes a regularization term relating to the neuron firing times in the spiking neural network.

According to the learning method, it is possible to eliminate or reduce the learning instability caused by invariance of the Softmax function with respect to a transformation that uniformly adds an identical value to the firing times of all of the neurons in the output layer.

In this respect, according to the learning method, the learning of a time-based spiking neural network can be performed with greater stability.

All or part of the neural network system 1, all or part of the neural network system 10, and all or part of the learning processing device 20 may be implemented by dedicated hardware.

FIG. 9 is a schematic block diagram showing a configuration example of dedicated hardware according to at least one example embodiment. In the configuration shown in FIG. 9, the dedicated hardware 500 includes a CPU 510, a primary storage device 520, an auxiliary storage device 530, and an interface 540.

When the neural network system 1 described above is implemented by the dedicated hardware 500, the operation of each of the above processing units (the neural network device 100, the neuron model units 121, the transmission processing units 122, the cost function computing unit 200, and the learning processing unit 300) is stored in the dedicated hardware 500 in the form of a program or circuit. The CPU 510 reads the program from the auxiliary storage device 530, expands the program to the primary storage device 520, and executes the processing of each processing unit according to the expanded program. Furthermore, the CPU 510 secures, according to the program, a storage area in the primary storage device 520 for storing various data. The input and output of data with respect to the neural network system 1 is executed by the CPU 510 controlling the interface 540 according to the program.

When the neural network system 10 described above is implemented by the dedicated hardware 500, the operation of each of the above processing units (the spiking neural network 11 and the learning processing unit 12) is stored in the auxiliary storage device 530 in the form of a program. The CPU 510 reads the program from the auxiliary storage device 530, expands the program to the primary storage device 520, and executes the processing of each processing unit according to the expanded program. Furthermore, the CPU 510 secures, according to the program, a storage area in the primary storage device 520 for storing various data. The input and output of data with respect to the neural network system 10 is executed by the CPU 510 controlling the interface 540 according to the program.

When the learning processing device 20 described above is implemented by the dedicated hardware 500, the operation of the learning processing unit 20 described above is stored in the auxiliary storage device 530 in the form of a program. The CPU 510 reads the program from the auxiliary storage device 530, expands the program to the primary storage device 520, and executes the processing of each processing unit according to the expanded program. Furthermore, the CPU 510 secures, according to the program, a storage area in the primary storage device 520 for storing various data. The input and output of data with respect to the neural network system 10 is executed by the CPU 510 controlling the interface 540 according to the program.

A personal computer (PC) may be used in addition to or instead of the dedicated hardware 500, and the processing in this case is the same as the processing in the case of the dedicated hardware 500 described above.

All or part of the neural network system 1, all or part of the neural network system 10, and all or part of the learning processing device 20 may be implemented as an ASIC

### (Application Specific Integrated Circuit).

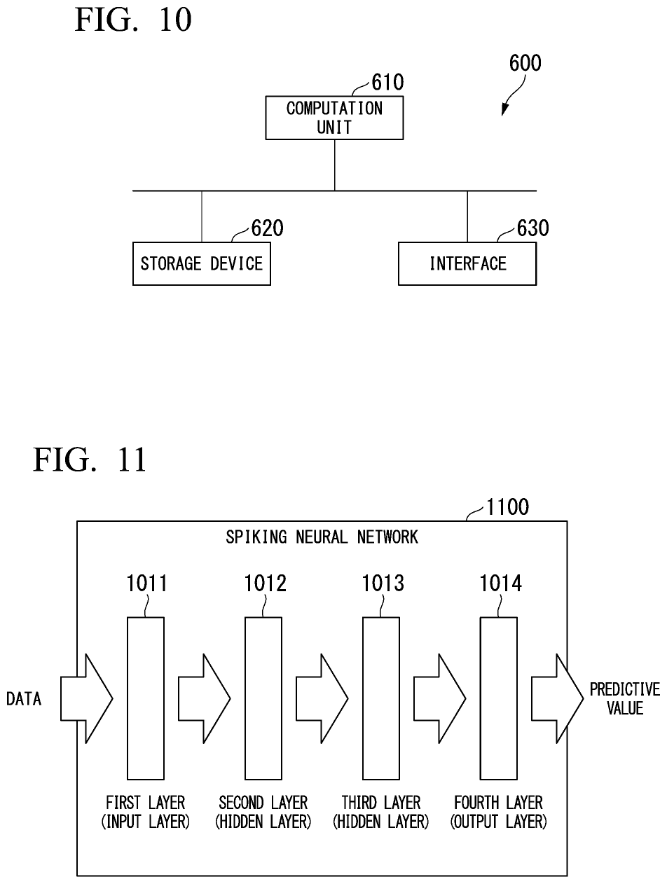

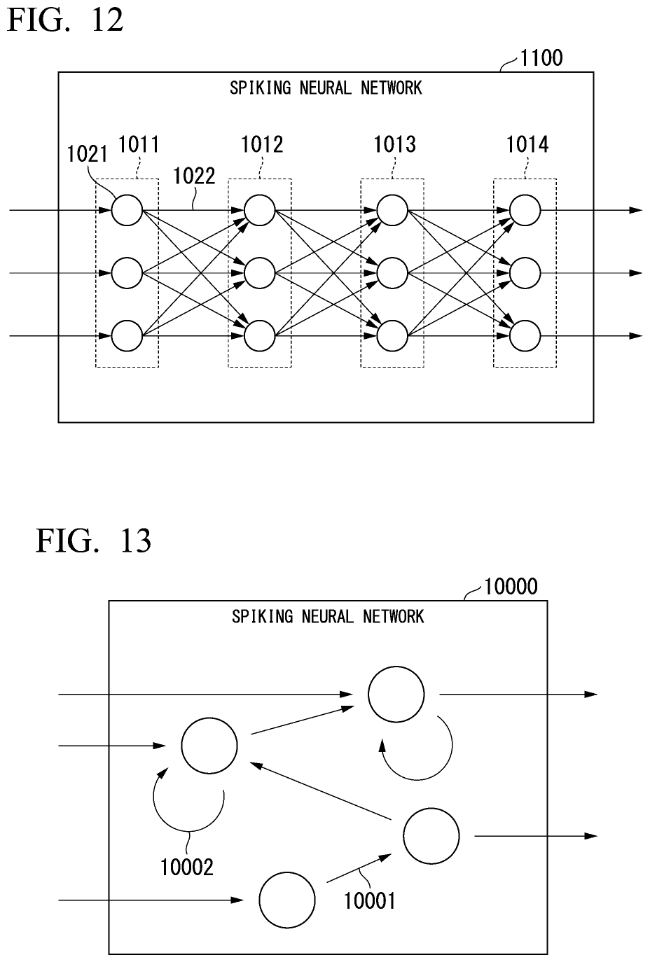

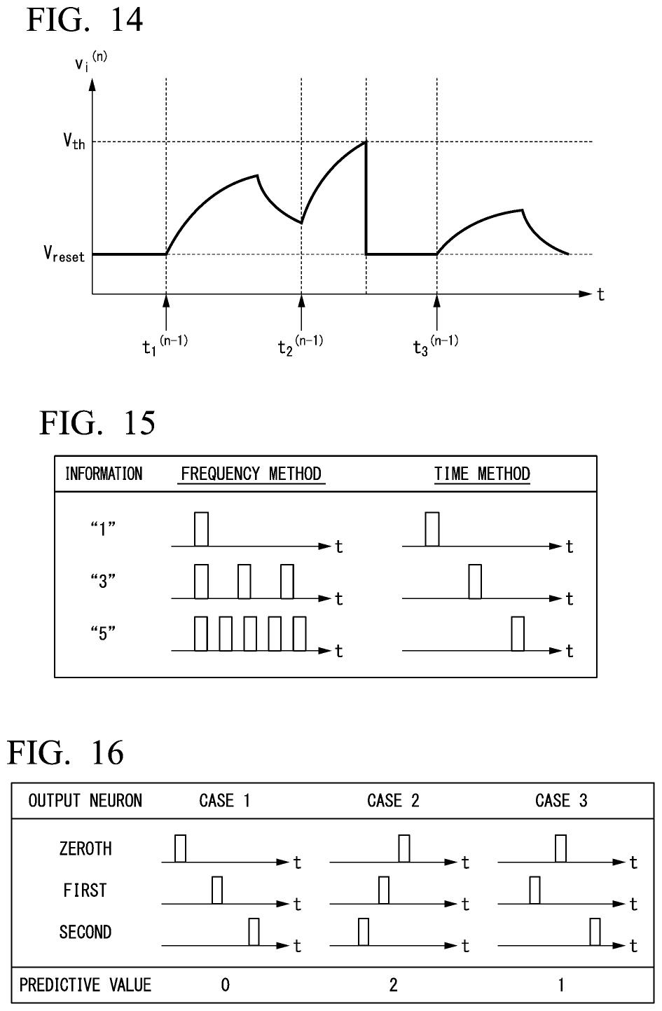

FIG. 10 is a schematic block diagram showing a configuration example of an ASIC according to at least one example embodiment. In the configuration shown in FIG. 10, the ASIC 600 includes a computing unit 610, a storage device 620, and an interface 630. Further, the computing unit 610 and the storage device 620 may be consolidated (that is to say, they may be integrally configured).

The ASIC implementing all or part of the neural network system 1, all or part of the neural network system 10, or all or part of the learning processing device 20 executes computations by means of an electronic circuit such as a CMOS. Each electronic circuit may independently implement the neurons in a layer, or may implement a plurality of neurons in a layer. Similarly, the circuits that compute the neurons may be used only for the computations of a certain layer, or may be used for the computations of a plurality of layers.

Furthermore, when the neural network is a recurrent neural network, the neuron models do not have to be hierarchical. In this case, each of the neuron models may be implemented by one of the electronic circuits at all times. Alternatively, the neuron models may be dynamically implemented by the electronic circuits, such as a case where the neuron models are assigned to the electronic circuits by time division processing.

A program for realizing some or all of the functions of the neural network system 1, the neural network system 10, and the learning processing device 20 may be recorded in a computer-readable recording medium, and the processing of each unit may be performed by a computer system reading and executing the program recorded on the recording medium. The “computer system” referred to here is assumed to include an OS (Operating System) and hardware such as peripheral devices.

Furthermore, the “computer-readable recording medium” refers to a portable medium such as a flexible disk, a magnetic optical disk, a ROM (Read Only Memory), or a CD-ROM (Compact Disc Read Only Memory), or a storage device such as a hard disk built into a computer system. Moreover, the program may be one capable of realizing some of the functions described above. Further, the functions described above may be realized in combination with a program already recorded in the computer system.

The example embodiments of the present invention have been described in detail above with reference to the drawings. However, specific configurations are in no way limited to the example embodiments, and include designs and the like within a scope not departing from the spirit of the present invention.

This application is based upon and claims the benefit of priority from Japanese patent application No. 2019-101531, filed May 30, 2019, the disclosure of which is incorporated herein in its entirety by reference.

### INDUSTRIAL APPLICABILITY

The present invention may be applied to a spiking neural network system, a learning processing device, a learning method, and a recording medium.

### REFERENCE SYMBOLS

1, 10 Neural network system
11 Spiking neural network
12, 300 Learning processing unit (learning processing means)
20 Learning processing device
100 Neural network device
121 Neuron model unit (neuron model means)
122 Transmission processing unit (transmission processing means)
200 Cost function computing unit (cost function computing means)

1. A spiking neural network system comprising:
a time-based spiking neural network; and
a learning processing means for causing learning of the spiking neural network to be performed by supervised learning using a cost function, the cost function including a regularization term relating to a firing time of a neuron in the spiking neural network.

2. The spiking neural network system according to claim 1, wherein the learning processing means causes the learning to be performed using the cost function that includes: a loss function that uses a negative log-likelihood of a Softmax function; and the regularization term, the negative log-likelihood the Softmax function being obtained by dividing a time index value obtained by inputting a value obtained by inputting time information of an output spike that has been multiplied by a negative coefficient into an exponential function, by a sum of the time index values of all neurons in an output layer.

3. The spiking neural network system according to claim 1, wherein the learning processing means causes the learning to be performed using the regularization term based on a difference between time information of an output spike and a reference time, the reference time being a constant.

4. The spiking neural network system according to claim 3, wherein the learning processing means causes the learning to be performed using the regularization term based on a square error of the difference.

5. A learning processing device comprising:
a learning processing means for causing learning of a time-based spiking neural network to be performed by supervised learning using a cost function, the cost function including a regularization term relating to a firing time of a neuron in the spiking neural network.

6. A learning method comprising:
performing learning of a time-based spiking neural network by supervised learning using a cost function, the cost function including a regularization term relating to a firing time of a neuron in the spiking neural network.

7. (canceled)
